(19) United States
(12) Patent Application Publication
(10) Pub. No.: US 2005/0013309 A1
(43) Pub. Date: Jan. 20, 2005

(54) System and method for high quality video conferencing with heterogeneous end-points and networks

(76) Inventors: Channasandra Ravishankar, Germantown, MD (US); Surekha Peri, Gaithersburg, MD (US)

Correspondence Address: THE DIRECTV GROUP, INC.;RE/R11/A109, P.O. BOX 956, EL Segundo, CA, 90245-0956, US

(21) Appl. No.: 10/870,637

(22) Filed: Jun. 17, 2004

Related U.S. Application Data
(60) Provisional application No. 60/486,967, filed on Jul. 14, 2003.

(51) Int. Cl. H04L 12/28

(52) U.S. Cl. 370/401

(57) ABSTRACT

The invention relates to improving the quality of media data in video conferences having end-points with heterogeneous capability sets. Transmission modes are negotiated based on the highest capability codecs supported by each respective end-point. Each end-point communicates data based on its individually negotiated transmission mode. Data translations are implemented as necessary to ensure that each end-point receives media data according to a transmission mode that it supports. Accordingly, all end-points in a multi-point video conference employ their most capable codecs, thereby greatly enhancing the overall media quality in multi-point video conferences having heterogeneous end-points.

### RELATED APPLICATIONS

This application is related to, and claims the benefit of the earlier filing date under 35 U.S.C. § 119(e) of U.S. Provisional Patent Application Ser. No. 60/486,967, filed Jul. 14, 2003, titled “System and Method for High Quality Videoconferencing With Heterogeneous Endpoints and Networks”; the entirety of which is incorporated herein by reference.

### BACKGROUND OF THE INVENTION

The present invention relates to improving the quality of audio and video data in video conference systems having heterogeneous end-points and networks. In a multi-point video conference, each end-point must exchange audio and video data (collectively media data) with every other end-point involved in the conference. Media data sent from one end-point to another is first coded according to predefined algorithms at the transmitting end-point and decoded by corresponding decoding algorithms at the receiving end-point. In order for two end-points to communicate properly, the end-point receiving the coded media data must be capable of decoding. Coding algorithms along with their corresponding decoding algorithms are commonly referred to as codecs.

To a large extent the capabilities of a video conferencing end-point are determined by the codec or codecs which it supports. For example, G.711 is a standard for transmitting digital audio/speech data promulgated by ITU-T. H.261 is an ITU-T standard governing the transmission of digital video data. In order for two video conference end-points to communicate audio data according to G.711, both end-points must include a G.711 compliant codecs. Similarly, in order for two video conference end-points to communicate video data according to H.261, each end-point must support H.261 compliant codecs.

G.711 and H.261 are based on older, more mature technologies. For example, H.323, another ITU-T standard governing video conferencing system, was issued in 1996 and mandates that all H.323 compliant end-points include G.711 and H.261 codecs for audio and video coding. Rapid advances in data compression technology, however, have led to the development of complex coding and decoding algorithms capable of delivering better quality audio and video signals at ever lower bit rates. Wideband audio codecs embodied in audio standards such as G.722, 7.22.1 and G.722.2 are now widely preferred for video conferencing. Similarly, highly efficient video codecs such as those defined in video standards H.263 and H.264 are available for providing higher quality video at lower bit rates. For example, G.722.2 with a bit rate of 23.04 kbs is equivalent in quality to G.722 having bit rate of 64 kbs. Similarly, H.264 compliant codecs provide video of similar or better quality to H.263 video codecs at half the bit rate, and at one fourth the bit rate of H.261 codecs. FIG. 1 shows the performance improvement with increasing bandwidth for more efficient codecs. Clearly, the newer higher bandwidth codecs are preferable to the older, less efficient, narrowband codecs.

Multi-point video conferences may be set up having a centralized or distributed architecture. FIG. 2 shows a block diagram of a multi-point video conference 10 having a centralized architecture. A multipoint control unit (MCU) 12 communicates directly with a plurality of video conference end-points A, B, C & D. The MCU 12 includes a media controller (MC) and a media processor (MP). The media controller is responsible for determining the capabilities of the end-points and establishing the data formats that will be employed throughout the video conference. The MP implements the data formats determined by the MC and is responsible for routing the media data between the participating end-points. A problem arises when various end-points participating in a video conference support different media codecs. For example, in the video conference displayed in FIG. 2, end-points A and B, support more efficient media codecs conforming to G.722.2 and H.264. End-point C supports mid-level G.722.1 and H.263 codecs, but end-point D may only support G.711 and H.261 codecs. In this case, end-point D cannot process data transmitted from end-points A, B, and C if they send media data encoded according G.722.2, G.722.1, and H.264 and H.263.

To resolve this problem, ITU-T standard H.323 mandates that all end-points support G.711 and H.261 media codecs regardless of whether they also support additional higher capability codecs. This ensures that at minimum all H.363 compliant video conference end-points will share at least one common audio and video codec. Therefore, even though different end-points in a multi-point video conference may not share the same high-end capabilities, they will nonetheless be able to communicate using the common G.711 audio and H.261 video codecs.

In a typical video conference the participating end-points initially exchange their capability sets in a mode negotiation phase. Once the capabilities of the various end-points are known, each end-point is then at liberty to send data to other end-points in any format that the receive end-point is capable of decoding. In a multi-point video conference with heterogeneous end-points, this amounts to using the highest capability codec common to all the participating end-points. In practice, this often means that video conferences are carried out using G.711 and H.261 codecs (the least capable common codecs), despite the fact that a majority of the participating end-points may support higher quality low bit rate codecs. Compatibility is ensured, but at the expense of the higher quality audio and video available to the end-points supporting more sophisticated codecs. In other words, the format and quality of the data exchange is dictated by the end-point having the least capable codecs.

In the centralized video conference shown in FIG. 2, the MCU 10 negotiates the codecs that will be employed to transmit data among the end-points A, B, C, and D during the video conference. The MCU 10 determines that end-points A and B support high quality media codecs compliant with G.722.2 and H.264. End-point C supports G.722.1 and H.263, whereas end-point D only supports G.711 and H.261. Since H.363 mandates that the end-points A, B, and C also support G.711 and H.261 codecs in addition to H.722.2 and H.264 or G.722.1 and H.263, the MCU 10 determines that G.711 and H.261 are the only media codecs common to all four end-points. Accordingly, the MCU 10 selects G.711 and H.261 as the transmission modes for audio and video data over the course of the video conference. The results of this mode negotiation are shown in FIG. 2, with the applicable media transmission standards designated for each communication link. As can be seen, the overall quality and speed of the media data transmissions are limited to G.711 and H.261 throughout the video conference even though three-quarters of the participants support more advanced codecs.

Video conferences may also be organized in a distributed architecture. In this arrangement, video conference end-points communicate with an MCU just as in the centralized architecture. However, in the distributed architecture, multiple MCUs interconnect with one another via a network. Each MCU recognizes the other MCUs simply as additional end-points. FIG. 3 shows a video conference 13 that includes three MCUs 14, 16 and 18. The MCUs are interconnected via a network 20. Video conference 13 includes five participating end-points. End-points 22 and 24 connect directly to MCU 14. End-point 24 supports only H.261 video coding and end-point 22 supports both H.261 and H.264 video coding. End-points 26 and 28 connect directly to MCU 16. End-point 26 supports H.261 and H.263 video coding, end-point 28 supports H.261 and H.264 coding. End-point 30 connects to MCU via a PDN network 34 and a gateway 32. End-point 30 supports only H.261 video coding.

The end-points participating in the video conference 13 have varying capabilities at least as far as their ability to code and decode a variety of media data signals. FIG. 3 shows the mode negotiations for video codecs only. Those skilled in the art will understand that similar discrepancies will likely exist between the audio codecs supported by the various end-points in such a distributed video conference. Since the manner of negotiating common audio codecs is the same for negotiating video codecs, the present discussion will be limited to the description of mode negotiations for determining common video codecs among the end-points participating in video conference 13. Mode negotiations for audio codecs are conducted in the same manner.

As with the centralized architecture shown in FIG. 2, media data transmission mode of the distributed video conference 13 is constrained by the end-point or end-points having the least capable codecs. As can be seen in FIG. 3, all of the data transmissions throughout the video conference 13 are limited to H.261. This is true even though many of the end-points participating in the conference support H.264 codecs. For example, all of the MCUs support H.264 coding yet the data transmitted between them is limited to H.261 coded data. The same is true for data transmitted between end-point 20 and MCU 12 and between end-point 24 and MCU 14, among others. This leads to a significant degradation in the quality of the media data available to the higher end components despite their enhanced capabilities.

Another restriction on the media quality available in multi-point video conferencing is bandwidth restrictions. Video conferencing is a bandwidth intensive application. Large amounts of bandwidth are required in order to achieve high quality media transmissions. Furthermore, bandwidth requirements increase as the number of conference participants increases. Accordingly, bandwidth restrictions in any of the links between the various end-points participating in a video conference can have a deleterious impact on the overall quality of the entire conference. High quality media data is readily achievable in non-congested environments such as on a LAN, but bandwidth becomes a bottleneck if an external network such as an ISDN, PDN, wireless, or satellite network is accessed. In such cases the media transported within the video conference must be transmitted well within the bandwidth limitations of the most restrictive communication segment.

FIG. 4 shows such a bandwidth constrained multi-point video conference. Each end-point communicates with a bridge/router/switch via a high bandwidth LAN 36. Each bridge/router/switch in turn accesses a bandwidth constrained network which transports the video conference media data between the various end-points. The quality of the video conference is constrained by the data rates that may be achieved across the narrowband network. If one or more of the participating end-points do not support higher bit rate codecs and the media data transmission modes are limited to G.711 and H.261, the low bandwidth bottleneck can have a significant negative impact on the quality of the media data.

A mechanism is needed whereby more advanced end-points supporting higher quality, lower bit rate codecs may take advantage of their higher capabilities even when participating in video conferences with end-points having lesser or dissimilar capabilities. Employing such a mechanism should allow end-points to communicate using their most efficient codecs despite the limitations of the other end-points participating in the videoconference and despite bandwidth restriction in the various links making up the video conference connections.

### SUMMARY OF THE INVENTION

The present invention relates to a method, system and apparatus for improving the quality of video conferences among video conference end-points having heterogeneous capability sets or occurring over heterogeneous networks.

According to the invention, mode negotiations occur between a multi-point control unit and various end-points participating in a video conference. The transmission modes are negotiated based on the most efficient highest capability media codecs commonly supported by the multi-point control unit and the various end-points. Thus, each end-point transmits and receives media data according to its most capable codec rather than the least capable codec as is common in the prior art in order to assure compatibility throughout the video conference. According to the invention, media data are translated from one transmission mode to another to ensure that end-points receiving transmitted media data are capable of decoding the received data. Using the present invention multi-point video conferences are freed from the restrictions imposed by the least capable end-point. Only the end-points having lower capability codecs are affected by their own limitations. End-points having superior capabilities are free to take advantage of the more sophisticated media codecs that they support. Accordingly the overall quality of the media data in the video conference is improved.

A method of negotiating media transmission modes in a multi-point video conference having heterogeneous end-points is provided. The method includes the step of determining the most efficient media codec supported by a first video conference end-point. Similarly, the most efficient media codec supported by a second video conference end-point is also determined. Once the capabilities of the two end-points have been determined, media data are transmitted and received to and from the first and second end-points encoded in a format determined by the most efficient codec supported by the first and second end-points, respectively. Media data encoded according to the most efficient codec supported by said first end-point are translated into media data encoded according to the most efficient media codec supported by said second end-point, and media data encoded according to said most efficient media codec supported by said second end-point are translated into media data encoded according to said most efficient media codec supported by said first end-point.

The present invention further provides a method for improving the media quality of a video conference that includes a communication segment having limited bandwidth. This aspect of the invention involves receiving media data encoded according to a first transmission mode at a first end of the constrained bandwidth communication segment. The media data received at the first end of the bandwidth constrained communication segment is then translated into a second, more bandwidth efficient transmission mode. The translated media data are then transmitted over the bandwidth constrained communication segment using the second more bandwidth efficient transmission mode.

According to another aspect of the invention, a multi-point video conferencing system is provided for video conferences having end-points with heterogeneous capabilities. The system includes at least one multi-point control unit (MCU). At least one of the video conference end-points is connected to the MCU for transmitting and receiving media data between the MCU and the at least one other end-point. According to this embodiment, the MCU is adapted to translate media data between media data transmission modes associated with the various end-points.

Finally, a video conference multi-point control unit is provided. The multi-point media control unit includes a media controller adapted to individually negotiate media data transmission modes between the multi-point control unit and each one of a plurality of video conference end-points. The end-points include heterogeneous capability sets. The transmission modes negotiated with each end-point are determined by the most efficient transmission mode commonly supported by the multi-point control unit and each respective end-point. The media control unit further includes a media processor for routing media data between various video conference end points and translating the media data from a transmission mode negotiated with a first end-point into a transmission mode negotiated with a second end-point.

By implementing the present invention, multiple end-points may participate in a video conference, each employing their full capabilities. Less capable end-points do not negatively impact the media quality of end-points having superior capabilities. Additionally, higher quality, lower bit rate codecs may be employed on narrow bandwidth communication segments to improve the data throughout on bandwidth restricted links. Thus, the overall quality of the media data in a multi-point video conference with heterogenous end-points is greatly improved.

Additional features and advantages of the present invention are described in, and will be apparent from, the following Detailed Description of the Invention and the figures.

### BRIEF DESCRIPTION OF THE FIGURES

FIG. 1 is a chart showing the improved performance characteristics of more efficient video codecs with increasing bandwidth.

FIG. 2 is a block diagram of a centralized video conference showing mode negotiations carried out according to the prior art.

FIG. 3 is a block diagram of a distributed video conference showing mode negotiations carried out according to the prior art.

FIG. 4 is a block diagram of a distributed video conference over a bandwidth constrained network.

FIG. 5 is a block diagram of a centralized video conference showing mode negotiations carried out according to the present invention.

FIG. 6 shows the audio data translations required to implement the centralized video conference shown in FIG. 5.

FIG. 7 shows the video data translations required to implement the centralized video conference shown in FIG. 5.

FIG. 8 is a block diagram of a distributed video conference showing mode negotiations carried out according to the present invention.

FIG. 9 shows a representative portion of the video data translations necessary to implement the distributed video conference shown in FIG. 8.

FIG. 10 shows a representative portion of the video translations necessary to implement a video conference over a bandwidth constrained network according to the present invention.

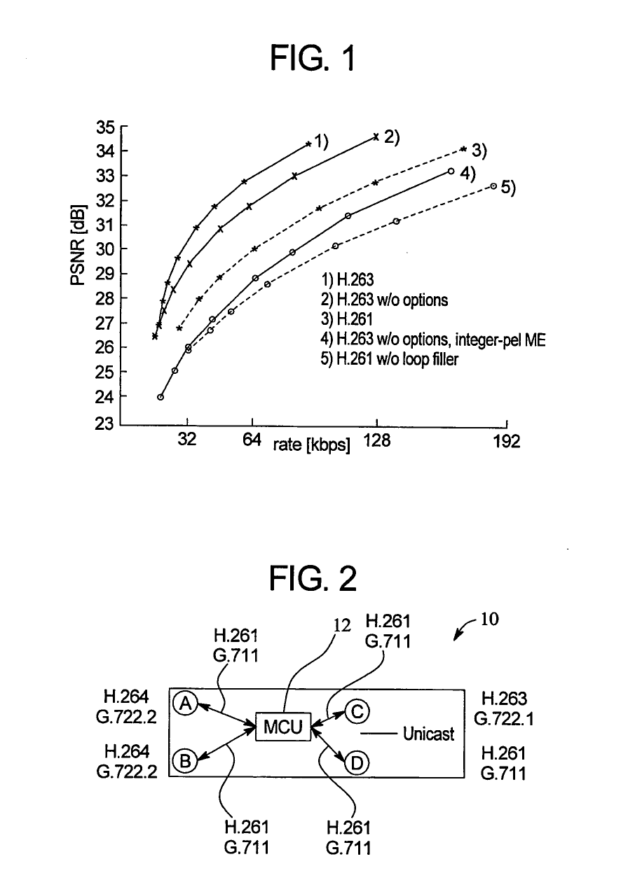

### DETAILED DESCRIPTION OF THE INVENTION

The present invention relates to a method, system and apparatus for improving the quality of media data transmitted in multi-point video conferences having heterogeneous end-points. The present invention allows end-points to take advantage of their best, most efficient codecs despite the limitations of other end-points participating in a video conference, and despite bandwidth restrictions in the communication links forming the connections for the video conference.

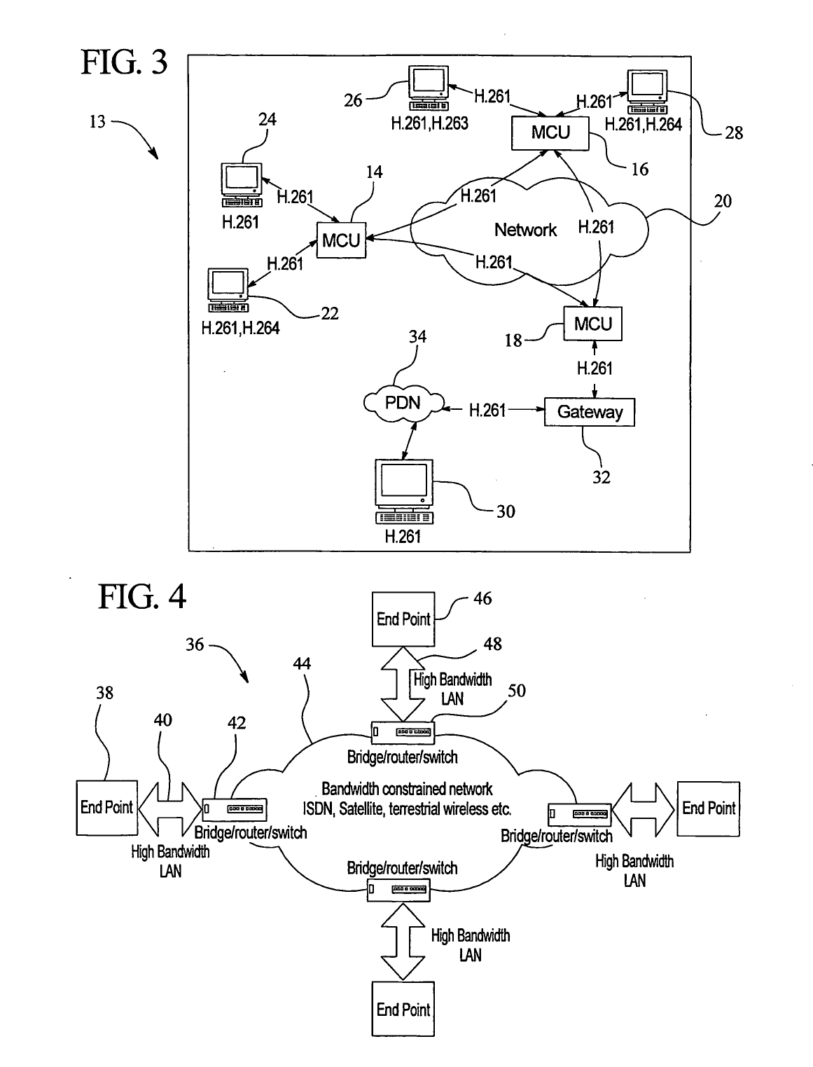

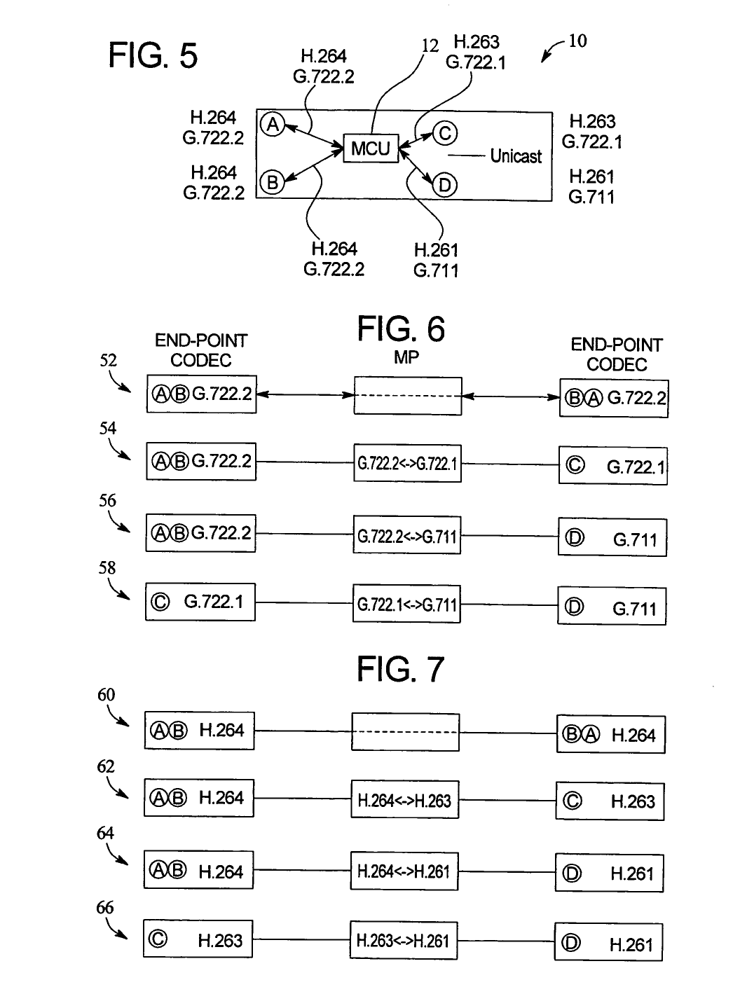

Turning to FIG. 5, a block diagram of centralized multi-point video conference 14 is shown. The architecture of the video conference is substantially identical to the architecture of the centralized video conference 10 shown in FIG. 3. Like components have been given the same designations. Thus, a single multi-point control unit 10 communicates with video conference end-points A, B, C and D. End-points A, B and C support G.722.2 audio coding and H.264 video coding. End-point C supports G.722.1 audio coding and H.263 video coding. End-point D supports only G.711 audio and H.261 video coding. MCU 10 includes a media controller (MC), and a media processor (MP). The difference between the centralized video conference of FIG. 3 and video conference of FIG. 5 lies in the mode nodes with each end-point individually based on the highest capability codec commonly supported by the MCU 16 and the individual end-points. The MCU negotiates transmission nodes with each end-point individually based on the highest capability codec commonly supported by the MCU 16 and the individual end-points. The MCU 12 in video conference of FIG. 5 negotiates transmission nodes with each end-point individually based on the highest capability codec commonly supported by the MCU 16 and the individual end-points. This generally allows each end-point to communicate with the MCU 12 using its most capable codec.

The transmission modes negotiated by the MCU 16 and the end-points are shown in FIG. 5 in association with corresponding communication links. The MP translates the media data as necessary to forward media data to the various end-points in formats the receiving end-points are capable of decoding. For example, video data received at MCU 12 from end-point A is coded according to H.264, since this is the most efficient video coding algorithm to end-point A. Data from end-point A may be sent directly to end-point B without translation since both end-points support H.264 compatible codecs. Thus, the connection between end-points A and B can take advantage of the higher video quality and lower bit rates provided by H.264 coding even though end-point D is limited to sending and receiving only H.261 encoded data. However, the H.264 encoded data from end-point A cannot be sent directly to end-point D since end-point D does not include an H.264 compatible codec and cannot decode H.264 encoded data. In order for H.264 coded data from end-point A to be successfully transmitted to end-point D it must be translated into a data format compatible with end-point D, namely H.261 encoded data. Transmissions to and from end-points A and B may occur according to the most capable (at present) codec H.264. Transmissions to and from end-points may take place according to the intermediate capabilities of a G.7221 and H.263 complaint codecs. Only transmissions to and from end-point D are limited to higher bit rate, lower quality H.261 codecs. Thus, the overall quality of the video conference is not held captive by the poorest performing end-point.

The media processor in MCU 10 is adapted to perform the appropriate media translations between the end-points having dissimilar capabilities. The necessary translations may be effected in at least two ways. Data encoded according to a first code may be decoded by a corresponding decoder and then re-coded according to a second code. Alternatively an algorithm may be provided for translating coded data directly from one coding format to another. FIG. 6 shows all of the audio codec translations that the MP of MCU 12 must perform in order to implement the video conference 10 according to the present invention. Communication path 52 represents data transmissions between end-points A and B. Since both support G.722.2 audio codecs, no translation is necessary. Communication path 54 represents data transmissions between end-points A or B and end point C. Here translations between G.722.2 and G.722.1 audio codecs are required.

Communication path 56 shows data transmissions between end-points A or B and end point D. Translations between G.722.2 and G.711 audio codecs are required for these data transmissions between end-point C and end-point D. Audio translations between G.722.1 and G.711 compliant codecs are required for these transmissions.

FIG. 7 shows all of the video data code translations necessary to implement the centralized video conference 14. The first communication path 56 shows data transmissions between end-points A or B and end point D. Translations between F.722.2 and G.711 audio codecs are required for these data transmissions. Finally, communication path 58 corresponds to data transmissions between end-point C and end-point D. Audio translations between G.722.1 and G.711 compliant codecs are required for these transmissions. Communication path 60 represents data transmissions between end-points A and B. Since end-points A and B both support H.264 codecs, no translations are necessary. The second path 62 represents data transmissions between either end-point A or B and end-point C. In this case, data transmissions from end-points A and B are encoded according to H.264 and data transmissions between end-point C and the MCU are encoded according to H.263. Therefore translations between H.264 and H.263 are required. Similarly for video data transmissions between end-points A or B and end-point D data must be translated between H.264 and H.261 codecs, as shown in communication path 64. Finally, for media data transmissions between end-points C and D video data must be translated between H.263 and H.261 codecs as shown in communication path 66.

Next we will consider the present invention applied to a video conference having a distributed architecture. Mode negotiations for video codecs will be described. Mode negotiations for audio codecs will be omitted for the sake of brevity. But those skilled in the art will readily understand that mode negotiations for audio codecs will take place in an identical manner as the video codec negotiations.

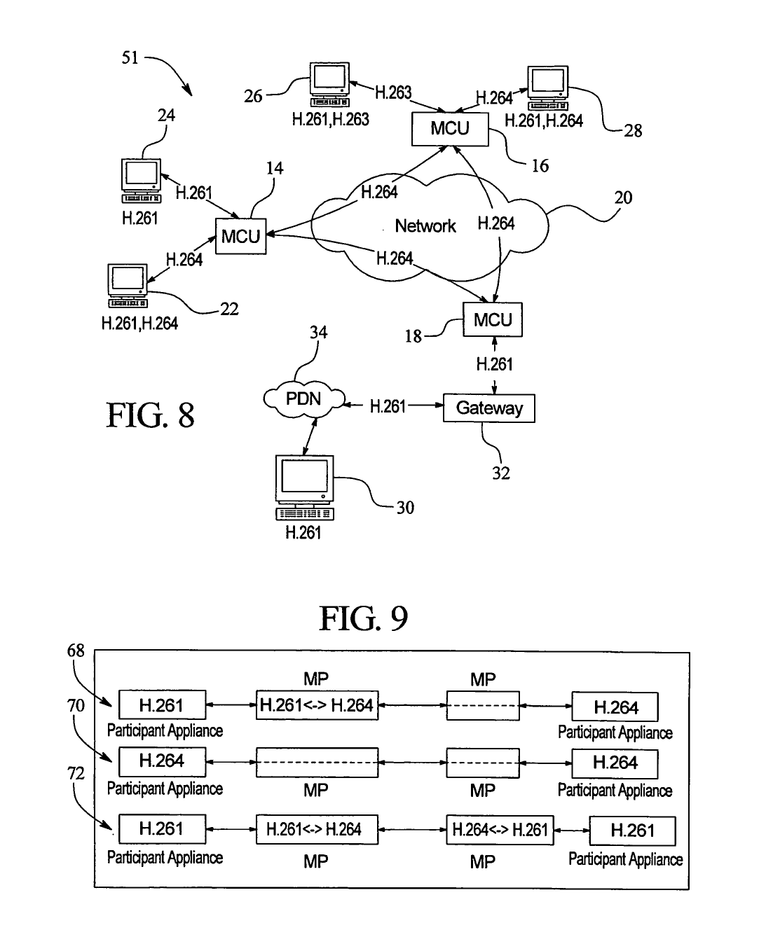

FIG. 8 shows the mode negotiations for a distributed video conference 51 established according to the present invention. The heterogeneous architecture of the conference 51 is substantially identical to the video conference shown in FIG. 3. Again, like components have been given the same reference numbers. MCU 14 connects directly to end-points 22, 24 and to MCUs 16, 18 via network 20. End-point 22 supports H. 261 and H.264 coding. End-point 24 supports H.261 coding only. MCU 16 connects directly to end-points 26, 28 and to MCUs 14, 18 via network 20. End-point 26 supports H.261 coding and H.263 coding. End-point 28 supports H.261 and H.264 coding. MCU 18 connects to end-point 30 via a gateway 32, and a PDN network 34. End-point 30 supports only H.261 coding.

Recall that in FIG. 3 mode negotiations performed according to the prior art resulted in data transmissions among all of the components participating in the video conference being conducted in a mode common to all participants, namely, the least efficient codecs compliant with H.261. In FIG. 8, however, mode negotiations are performed according to the present invention. This results in media data transmissions modes selected according to the best transmission mode commonly supported by the two components at either end of each transmission. For example, each MCU 14, 18 supports H.264 compliant codecs. Therefore, all of the video data transmissions between the MCUs 14, 16 and 18 employ the more efficient H.264 coding. Similarly, transmissions between MCU 14 and end-point 22 and between MCU 16 and end-point 28 also employ H.264 codecs since both of these end-points employ H.264 codecs. Transmissions between MCU 16 and end-point 26 employ H.263 coding, and transmissions between MCU 14 and end-point 24 employ H.261 coding, as do transmissions between MCU 16 and gateway 28, and transmissions between the gateway 28 and end-point 26 over the PDN network 32 since H.261 is the only codec supported by these devices.

FIG. 9 shows a representative selection of the various translations that must be carried out to implement the transmission modes in video conference 51. The first path 68 shows the translations necessary for video translations between a first end-point such as end-point 42 that supports only H.261 coding and an end-point such as end-point 28 that supports H.264 coding. The end-point 24 sends and receives H.261 coded data to and from the MCU 14. The MP associated with MCU 14 translates between H.261 and H.264 encoded data. MCUs 14 and 16 send media data to one another using H.264 codes. Since end-point 28 also supports H.264 coding, no translation is required by the MP associated with MCU 16 to communicate with end-point 28. The second communication path 70 shows the translations necessary for data transmissions from an end-point such as end-point 22 that supports compliant codec and another end-point, such as end-point 28, that also supports an H.264 compliant codec. As can be seen, since all of the components support highly efficient H.264 codes, no translations are necessary.

The third communication path 72 shows the translations necessary for data transmissions between two end-points that are limited to H.261 codes. For example, communication path 72 could represent the data transmissions between end-point 24 and end-point 30. At both ends of the transmission path, the corresponding MCUs communicate media data with the end-points using narrowband H.261 codecs. The MPs associated with the MCUs 14, 18 translate video data between H.261 and H.264 coded data. Thus, video data transmissions between the MCUs can take place using higher quality, lower bit rate H.264 codecs even though the two end-points involved can only decode and transmit video data using H.261 codecs. This feature provides significant improvement in the media quality of video conferences, especially those where in are rejected under 35 U.S.C. § 102 as anticipated by segment of the media data must be transmitted over a bandwidth limited communication segment. (This feature will be described in more detail below.) Though not shown in FIG. 9, similar translations are required between heterogeneous end-points supporting H.261 and H.263 codecs and between end-points support H.263 and H.264 codecs. The results of the mode negotiations according to the present invention are shown in FIG. 8. The negotiated modes are shown within each respective communication link.

This system allows each end-point to use its highest performing codec regardless of the limitations of the other end-points. Only those end-points having limited capabilities are constrained to the lower quality codecs. Accordingly, the overall quality of a video conference having heterogeneous end-points is improved and is not restricted to by the capabilities of the least capable participating end-point.

Next we will describe how the present invention is able to take advantage of the higher bandwidths available on LANs compared those typically available on WANs, when an endpoint having a lower quality codec is admitted into a video conference. Returning to FIG. 4, suppose that both end-points 38 and 46 are limited to G.711 audio and H.261 video codecs. The high bit rate of G.711 and H.261 codecs will not significantly impact the media quality for transmissions across the low traffic high bandwidth LANs 40, 48. However, the high bit rate of H.261 codes will have a significant deleterious effect on media data transmissions that must traverse the bandwidth constraining network 44, such as when media data are exchanged between end-points 38, 46. The solution to this problem is to translate the media data encoded according to the higher bit rate H.261 codecs into a more efficient high quality, low bit rate codec and transmit the media data over the narrowband segment using the lower bit rate codec. In this way, higher quality video may be sent across the constrained link at a higher rate, thereby improving the overall quality of the video conference.

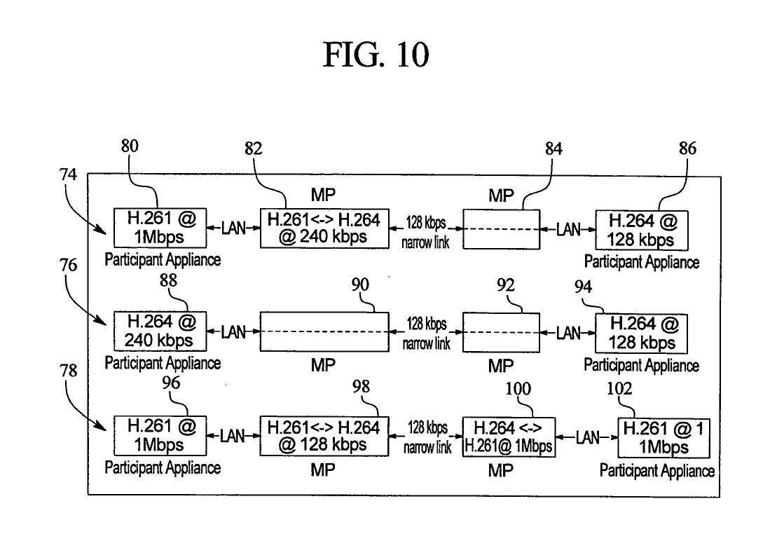

FIG. 10 shows representative video codec translations for implementing the present invention in a video conference having heterogeneous end-points and at least one narrowband communications link. In the first communication path 74 a video conference endpoint 80 supporting only an H.261 video codec communicates with the MP 82 of a first MCU via a high bandwidth LAN. The MP 82 communicates with the MPs of other MCUs, such as MP 84 via a narrow band 128 KPS WAN. Finally, the MP 84 communicate with video conferences endpoint 86 which supports high quality video codec H.264, via another high bandwidth LAN. The MCU associated with MP 82 negotiates a very high bit rate, in this case 1 MPS, to compensate for the lower quality of the H.261 codec supported by endpoint 80. This is possible due to the high bandwidth capacity of the LAN. On the other hand, the MCU associated with MP 84 negotiates a lower bit rate, 128 KPS, with the endpoint 86 which supports the higher quality H.264 video codec. The only translation necessary is at MP 82 between the higher bitrate H.261 video codec on endpoint 80 and the lower bitrate higher quality H.264 video codec. Thus, the lower quality of the H.261 video codec is offset by the higher bitrate to compensate for the inherent quality differences between H.261 and H.264.

In cases where both endpoints support the higher quality codec H.264, such as communications path 76, no translation are required. MPs 90 and 92 negotiate the highest bit rates allowed by the IR respective network connections. In communication path 78 both endpoints 96 and 102 support only H.261 video high bit rates with the low quality H.261 endpoints, but translate the video signals to H.264 for transmission over the narrow band link between the MPs, providing the highest quality video possible despite the various system constraints.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A method of negotiating media transmission modes in a multi-point video conference having heterogeneous end-points, comprising:
determining a most efficient media codec supported by a first video conference a first end-point;
determining a most efficient media codec supported by a second video conference end-point;
transmitting and receiving media data to and from said first video conference endpoint encoded according to said most efficient media codec supported by said first video conference end-point;
transmitting and receiving media data to and from said second video conference end-point encoded according to said most efficient media codec supported by said second video conference end-point;
translating media data encoded according to said most efficient codec supported by said first video conference end-point into media data encoded according to said most efficient media codec supported by said second video conference end-point; and
translating media data encoded according to said most efficient media codec supported by said second video conference end-point into media data encoded according to said most efficient media codec supported by said first video conference end-point.

2. The method of claim 1 wherein said most efficient media codec supported by said first end-point is a codec compliant with ITU-T H.323.

3. The method of claim 1 wherein said most efficient media codec supported by said first end-point is a codec compliant with an ITU-T-video codec.

4. A method of establishing a multi-point video conference comprising:
identifying a plurality of end-points participating in the conference;
providing a multi-point control unit for controlling media data flow within said video conference;
negotiating media transmission modes between each end-point and said multi-point control unit based on the most efficient media transmission mode supported by each end-point; and
transmitting media data between the multi-point control unit and each individual end-point among said plurality of endpoints according to the transmission mode negotiated between the multi-point control unit and each individual end-point.

5. The method of claim 4 further comprising translating media data transmitted according to a first transmission mode negotiated with a first individual end-point into a second transmission mode negotiated with a second individual end-point.

6. The method of claim 5 wherein said first transmission mode comprises an ITU-T video codec.

7. The method of claim 6 wherein said first transmission mode comprises one of H.261; H.263; or H.264.

8. The method of claim 5 wherein said first transmission mode is a codec compliant with ITU-T-H.323.

9. The method of claim 8 wherein said first transmission mode comprises one of G.711; G.722; G.722.1; or G.722.2.

10. A method of improving the media quality of a video conference that includes a constrained bandwidth communication segment comprising:
receiving media data according to a first transmission mode at a first end of said constrained bandwidth communication segment;
translating said media data from said first transmission mode into a second, more bandwidth efficient transmission mode; and
transmitting said media data over said bandwidth constrained communication segment in said second more bandwidth efficient transmission mode.

11. The method of claim 10 wherein said second more bandwidth efficient transmission mode comprises H.264.

12. The method of claim 10 wherein said second more bandwidth efficient transmission mode comprises G.722.2.

13. The method of claim 10 wherein said first transmission mode comprises one of H.264, or H.263.

14. The method of claim 10 wherein said transmission mode comprises one of G.711; G.722; or G.722.1.

15. The method of claim 10 further comprising receiving said media data transmitted over said bandwidth constrained communication segment and translating said media data from said second more bandwidth efficient transmission mode back into said first transmission mode.

16. The method of claim 10 further comprising receiving said media data transmitted over said bandwidth constrained communication segment and translating said media data from said second more efficient transmission mode into a third transmission mode.

17. A multi-point video conferencing system comprising:
a plurality of video conference end-points;
a multi-point control unit connected to a portion of said plurality of end-points for transmitting and receiving media data to and from said end-points, said multi-point controller adapted to translate media data between media data transmission modes associated with the various end-points.

18. The multi-point video conferencing system of claim 17 wherein said end-points include one or more additional multi-point control units.

19. The multi-point video conferencing system of claim 17 comprising a plurality of said multi-point control units, said multi-point control units interconnected via a network.

20. The multi-point video conferencing system of claim 19 wherein said multi-point control unit is adapted to translate video data between H.261, H.263 or H.264.

21. The multi-point video conferencing system of claim 20 wherein said multi-point control unit is adapted to translate audio data between G.711, G.722, G.722.1 or G.722.2.

22. A multi-point control unit for multi-point video conferencing comprising:
a media controller adapted to individually negotiate media data transmission modes between the multi-point control unit and each one of a plurality of video conference end-points based on the most efficient transmission mode supported by the multi-point control unit and each individual end-point; and
a media processor for routing media data between said individual end-points and translating said media data from a transmission mode negotiated with a first end-point into a transmission mode negotiated with a second end-point.

23. A method of improving the quality of a video conference having heterogeneous endpoints and at least one communication segment having limited bandwidth capabilities, the method comprising:
negotiating a high bit rate with endpoints supporting lower quality codecs;
translating media data encoded according to the lower quality codec into media data encoded according to a higher quality codec;
transmitting the data encoded according to the higher quality codec at a lower bit rate over the communication segment having limited bandwidth capabilities.
